(19) United States
(12) Patent Application Publication
(10) Pub. No.: US 2020/0041077 A1
(43) Pub. Date: Feb. 6, 2020

(54) LIGHTING APPARATUS

(71) Applicant: PANASONIC INTELLECTUAL PROPERTY MANAGEMENT CO., LTD., Osaka (JP)

(72) Inventors: Kazuyuki YAMAE, Nara (JP); Hiroshi KITANO, Hyogo (JP)

(73) Assignee: PANASONIC INTELLECTUAL PROPERTY MANAGEMENT CO., LTD., Osaka (JP)

(21) Appl. No.: 16/527,181

(22) Filed: Jul. 31, 2019

(30) Foreign Application Priority Data
Aug. 6, 2018 (JP) 2018-147588

(51) Int. Cl. F21K 9/64; F21K 9/62; F21V 29/70; F21V 29/502; F21V 13/14; F21V 8/00

(52) U.S. Cl. CPC F21K 9/64; F21K 9/62; F21V 29/70; F21Y 2115/30; F21V 13/14; G02B 6/0008; G02B 6/0006; F21V 29/502

(57) ABSTRACT

A lighting apparatus includes a laser that emits laser light. A transmission component transmits the laser light. The laser light transmitted by the transmission component enters and is emitted by an optical connector. A wavelength converter emits wavelength-converted light according to the laser light emitted from the optical connector. A lens causes the laser light emitted from the optical connector to enter the wavelength converter. A luminaire emits the wavelength-converted light. The luminaire includes a holder that removably holds the optical connector. The optical connector includes: an optical component that is light-transmissive, mixes the laser light that enters, and emits the mixed laser light; and a case that has a light-blocking property and houses the optical component and part of the transmission component. The lens is in an optical path from the optical connector to the wavelength converter.

### CROSS REFERENCE TO RELATED APPLICATION

This application claims the benefit of priority of Japanese Patent Application Number 2018-147588 filed on Aug. 6, 2018, the entire content of which is hereby incorporated by reference.

### BACKGROUND

### 1. Technical Field

The present disclosure relates to a lighting apparatus that uses laser light.

### 2. Description of the Related Art

There is disclosed a lighting apparatus which includes a laser for emitting laser light, a wavelength converter for emitting light of a different wavelength than the laser light, an optical fiber cable for guiding the laser light from the laser to the wavelength converter, and a connector which is held in one end of the optical fiber cable and optically connected to the optical fiber (for example, see Japanese Unexamined Patent Application Publication No. 2010-62108).

### SUMMARY

In a conventional lighting apparatus, dirt, dust, and the like, are deposited on the portion of the optical connector from which laser light exits, during repeated attachment and detachment of the optical connector to and from the lighting apparatus, and thus there are instances where the optical connector is damaged due to heat buildup. Furthermore, when the optical connector becomes detached from the lighting apparatus for some reason during use of the lighting apparatus, leakage of laser light may cause personal injury.

In view of this, the present disclosure provides a lighting apparatus that reduces optical connector damage and has excellent safety.

A lighting apparatus according to an aspect of the present disclosure includes: a laser that emits laser light; a transmission component that transmits the laser light; an optical connector into which the laser light transmitted by the transmission component enters and from which the laser light is emitted; a wavelength converter that emits wavelength-converted light according to the laser light emitted from the optical connector; a first lens that causes the laser light emitted from the optical connector to enter the wavelength converter; and a luminaire that emits the wavelength-converted light, wherein the luminaire includes a holder that removably holds the optical connector, the optical connector includes: an optical component that mixes the laser light that enters, and emits the laser light that has been mixed, the optical component being light-transmissive; and a case that houses the optical component and part of the transmission component, the case including a light-blocking property, and the first lens is in an optical path from the optical connector to the wavelength converter.

A lighting apparatus according to the present disclosure reduces optical connector damage and has excellent safety.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1A is a perspective view of a lighting apparatus according to Embodiment 1;

FIG. 1B illustrates a schematic diagram of an excitation light source, and a cross-sectional view of a luminaire, etc., taken along line IB-IB in FIG. 1A, in the lighting apparatus according to Embodiment 1;

FIG. 2A is an enlarged partial cross-sectional view of the lighting apparatus according to Embodiment 1;

FIG. 2B is a cross-sectional view illustrating the appearance of an optical connector being attached to the luminaire, in the lighting apparatus according to Embodiment 1;

FIG. 2C is an enlarged partial cross-sectional view of when an optical component such as a diffuser, a fly's eye lens, or the like, is used in the lighting apparatus according to Embodiment 1;

FIG. 3 is an enlarged partial cross-sectional view of a lighting apparatus according to Embodiment 2;

FIG. 4 illustrates a schematic diagram of an excitation light source, and a cross-sectional view of a luminaire, in a lighting apparatus according to Embodiment 3;

FIG. 5 is an enlarged partial cross-sectional view of a lighting apparatus according to Embodiment 3; and

FIG. 6 is an enlarged partial cross-sectional view of a lighting apparatus according to Embodiment 4.

### DETAILED DESCRIPTION OF THE EMBODIMENTS

Hereinafter, exemplary embodiments of the present disclosure will be described with reference to the drawings. It should be noted that each of the subsequently-described exemplary embodiments show a specific preferred example of the present disclosure. Therefore, numerical values, shapes, materials, structural components, the arrangement and connection of the structural components, etc., indicated in the following exemplary embodiments are mere examples, and are not intended to limit the scope of the present disclosure. Therefore, among the structural components in the following exemplary embodiments, components not recited in any one of the independent claims which indicate the broadest concepts of the present disclosure are described as arbitrary structural components.

It should be noted that the drawings are schematic diagrams, and do not necessarily provide strictly accurate illustration. Furthermore, in the drawings, substantially identical components are assigned the same reference signs, and overlapping description is omitted or simplified.

Hereinafter, a lighting apparatus according to exemplary embodiments of the present disclosure will be described.

### Embodiment 1

[Configuration]

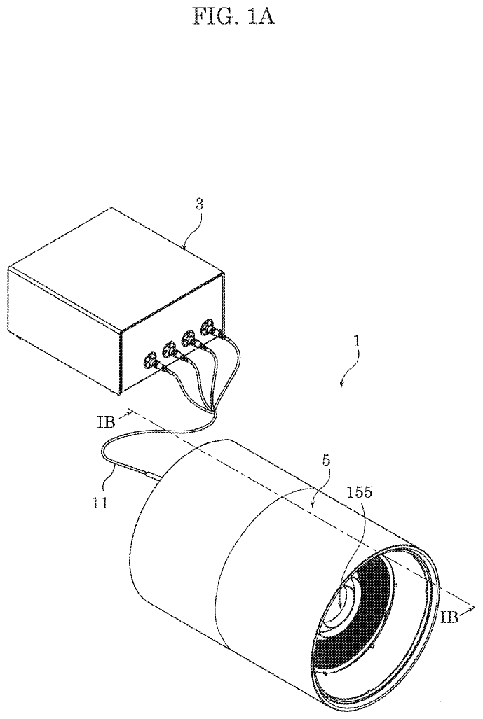

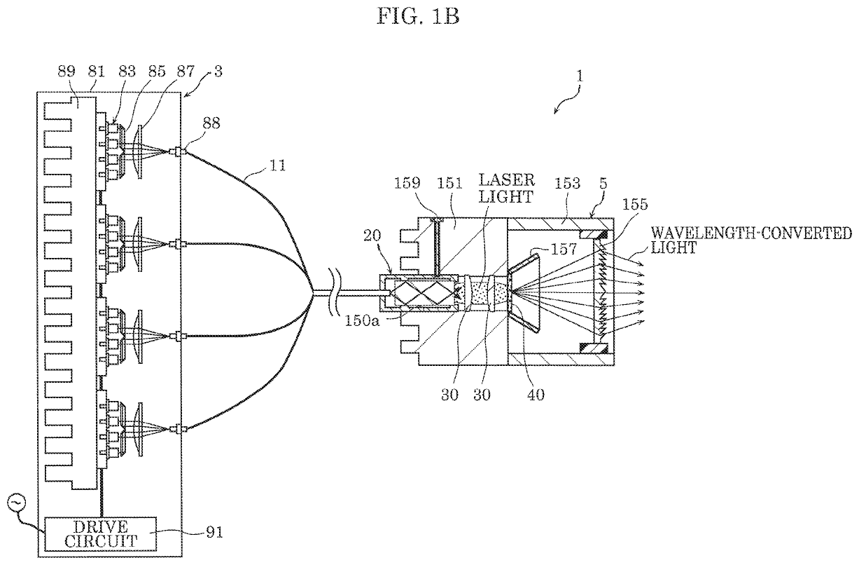

FIG. 1A is a perspective view of lighting apparatus 1 according to Embodiment 1. FIG. 1B illustrates a schematic diagram of excitation light source 3 and a cross-sectional view of luminaire 5, etc., taken along line IB-IB in FIG. 1A, in the lighting apparatus according to Embodiment 1. FIG. 2A is an enlarged partial cross-sectional view of lighting apparatus 1 according to Embodiment 1.

As illustrated in FIG. 1A and FIG. 1B, in lighting apparatus 1, wavelength-converted light obtained by wavelength converter 40 converting the wavelength of laser light is emitted, as illumination light, from luminaire 5. Luminaire 5 is for example a downlight, a spotlight, or the like.

As illustrated in FIG. 1B and FIG. 2A, lighting apparatus 1 includes a plurality of transmission components 11, optical connector 20, a plurality of first lenses 30, wavelength converter 40, luminaire 5, and excitation light source 3 including a plurality of lasers 83.

Each of transmission components 11 is an optical fiber cable that transmits the laser light emitted by excitation light source 3 to optical connector 20. In the present embodiment, a plurality of transmission elements 11 are provided. The laser light emitted by excitation light source 3 enters at one end of transmission component 11 and exits at the other end of transmission component 11. Transmission component 11 is formed using a material such as silica glass or plastic, for example. Hereinafter, “one end” means upstream of the path transmitting the laser light, and “the other end” means downstream of the path transmitting the laser light.

As illustrated in FIG. 2A, optical connector 20 consolidates the respective beams of laser light transmitted by the plurality of transmission components 11. Specifically, optical connector 20 mixes the respective beams of laser light transmitted by the plurality of transmission components 11, and emits the mixed laser light. It should be noted that, naturally, optical connector 20 can also mix laser light transmitted by a single transmission component 11.

Optical connector 20 is removably secured to luminaire 5. Optical connector 20 is secured to luminaire 5 by securing component 159 such as a screw, for example. FIG. 2B illustrates the appearance of optical connector 20 being attached to luminaire 5. FIG. 2B is a cross-sectional view of the appearance of optical connector 20 being installed in luminaire 5, in lighting apparatus 1 according to Embodiment 1.

As illustrated in FIG. 2B, optical connector 20 includes case 120 and optical component 130.

Case 120 is a cylindrical body that houses optical component 130. Space 123 through which the laser light passes is formed in case 120. Specifically, opening 125a is formed in one end of case 120 and opening 125b is formed in the other end. Transmission components 11 which transmit laser light are inserted through opening 125a at the one end of case 120 so as to plug up opening 125a. In the present embodiment, the laser light passes through opening 125b at the other end of case 120. Space 123 through which laser light passes is from opening 125a at one end up to opening 125b at the other end.

Case 120 has a light-blocking property. Case 120 is formed using a metal material such as aluminum or steel for example. In case 120, laser light passes through from opening 125a at one end to opening 125b at the other end.

Case 120 includes first engaging component 127 which engages with securing component 159 for securing to luminaire 5. First engaging component 127 is, for example, a recess into which securing component 159 is inserted or a protrusion that abuts with securing component 159 to thereby suppress movement of optical connector 20, etc. First engaging component 127 is formed in the outer peripheral surface of case 120. Securing component 159 is a male screw.

Case 120 includes, internally, annular support pieces 129a and 129b which secure optical component 130.

From the perspective of light entrance efficiency of the laser light emitted from transmission components 11, optical component 130 is disposed inside case 120, that is, space 123, separated from transmission components 11. Optical component 130 is fitted into the inside of case 120 and secured by support pieces 129a and 129b. Optical component 130 is disposed so as to block opening 125b at the other end of case 120. Specifically, the gap between optical component 130 and transmission components 11 is enclosed by case 120 to prevent entry of dirt, dust, etc. One end surface 131a (entrance surface) of optical component 130 is located opposite opening 125a at one end of case 120, and other end surface 131b of optical component 130 is located opposite opening 125b at the other end of case 120. One end surface 131a of optical component 130 is the entrance surface of laser light and other end surface 131b of optical component 130 is the exit surface of the laser light.

Optical component 130 is a columnar body and is light-transmissive. The laser light transmitted by transmission components 11 enter optical component 130 and are mixed inside. In optical component 130, the laser light transmitted by transmission components 11 enter from one end surface 131a, pass through the inside, and exit from other end surface 131b.

Optical component 130 is for example a rod integrator, or the like. As illustrated in FIG. 2C, optical component 130a may be a diffuser that diffuses the laser light, a fly's eye lens, etc. FIG. 2C is an enlarged partial cross-sectional view of when a diffuser, a fly's eye lens, or the like, is used in optical component 130a of lighting apparatus 1 according to Embodiment 1. When optical component 130a is a diffuser, a fly's eye lens, or the like, the size of optical connector 20a in the lengthwise direction (i.e., the length) can be reduced. Optical component 130a is formed using a material such as silica glass or plastic, for example.

As illustrated in FIG. 2A, first lenses 30 are disposed in the path from optical connector 20 to wavelength converter 40. In the present embodiment, one of first lenses 30 is disposed inside luminaire 5 so as to be located opposite other end surface 131b of optical component 130 via opening 125b at the other end of case 120. The other of first lenses 30 is disposed inside luminaire 5 so as to be located opposite the one of first lenses 30. The one of first lenses 30 is a convex lens whose other surface protrudes toward the direction of travel of the laser light. Furthermore, the other of first lenses 30 is a convex lens whose one surface protrudes toward the direction opposite to the direction of travel of the laser light. It should be noted that, since it is sufficient that laser light can be made to enter wavelength converter 40, first lenses 30 may be convex lenses.

It should be noted that optical path in the present embodiment means, not only to the optical path through which laser light emitted from laser 83 is transmitted to wavelength converter 40, but also includes the optical path up to the point where the wavelength-converted light resulting from the wavelength conversion by wavelength converter 40 exits from second lens 155 of lighting apparatus 1.

Wavelength converter 40 emits wavelength-converted light according to the laser light emitted from optical connector 20. Wavelength converter 40 is, for example, phosphor that emits fluorescence according to the laser light emitted from optical connector 20 via the plurality of first lenses 30. The phosphor is for example an yttrium aluminum garnet (YAG)-based phosphor or a Ba, Mg, Al (BAM)-based phosphor, and can be selected as appropriate according to the type of laser light. In the present embodiment, the laser light that enters wavelength converter 40 combines with blue laser light and wavelength-converted light to produce white wavelength-converted light.

Wavelength converter 40 is held in a dispersed state in a binder which is a transparent material formed from ceramic, silicone resin, or the like. Specifically, the binder is a medium which holds wavelength converter 40. The binder that holds wavelength converter 40 is not limited to ceramic or silicone resin, and other transparent materials such as transparent glass, or the like, may be used. Wavelength converter 40 may be a phosphor including the binder.

It should be noted wavelength converter 40 may be, for example, a red phosphor, a green phosphor, a blue phosphor, etc., and fluorescence such as red light, green light, blue light, etc., may be emitted according to the laser light. In this case, the red, green, and blue wavelength-converted light may be combined to produce white light.

Wavelength converter 40 may include multiple types of phosphors which absorb a portion of the blue laser light from excitation light source 3 and wavelength-convert it into green to yellow wavelength fluorescence. In this wavelength converter 40, when the blue laser light from excitation light source 3 is emitted, the green to yellow wavelength fluorescence generated from the portion of the blue laser light that is absorbed and wavelength-converted by the phosphors combines with the blue laser light that is transmitted without being absorbed by the phosphors such that pseudo white wavelength-converted light is emitted.

Luminaire 5 is a device that emits wavelength-converted light obtained through the wavelength-conversion by wavelength converter 40. Luminaire 5 includes first heat sink 151, exterior portion 153, second lens 155, reflecting component 157, and securing component 159.

First heat sink 151 is a heat-dissipating component that dissipates heat generated in optical connector 20 and wavelength converter 40, and includes a plurality of fins. First heat sink 151 holds wavelength converter 40 so that wavelength converter 40 is located opposite other end surface 131b of optical component 130 in optical connector 20, via first lenses 30. In other words, wavelength converter 40 is disposed on the other end of holder 150a to be described later. First heat sink 151 is an example of a heat sink.

First heat sink 151 includes holder 150a that holds optical connector 20. Holder 150a is an insertion hole which holds optical connector 20 when optical connector 20 is inserted therein. Holder 150a secures above-described each of first lenses 30 so that the convex portions of the two first lenses 30 face each other. Holder 150a secures optical connector 20 in a predetermined orientation so as to be located opposite the one of first lenses 30.

Second engaging component 159a, into which securing component 159 is inserted for securing optical connector 20, is formed in first heat sink 151. When optical connector 20 is installed in luminaire 5, second engaging component 159a is located opposite first engaging component 127 formed in case 120 of optical connector 20. First engaging component 127 and second engaging component 159a are female screws.

Exterior portion 153 is connected to first heat sink 151 and disposed downstream in the optical path. Exterior portion 153 is a cylinder having openings which open to the front and back of the optical path.

Second lens 155 is secured to exterior portion 153 so as to block an opening of exterior portion 153. Specifically, second lens 155 is secured to exterior portion 153 in an orientation that is opposite to wavelength converter 40 to enable entry of the wavelength-converted light emitted from wavelength converter 40. Second lens 155 is for example a Fresnel lens. Second lens 155 controls the light distribution of the wavelength-converted light to perform predetermined lighting.

Reflecting component 157 reflects the wavelength-converted light emitted from wavelength converter 40 toward second lens 155. Reflecting component 157 is bowl-shaped with a diameter that increases from wavelength converter 40 toward second lens 155. Reflecting component 157 is secured to the other end surface of first heat sink 151 so as to surround the periphery of wavelength converter 40 and be facing second lens 155.

Excitation light source 3 is a device that emits laser light. Excitation light source 3 includes housing 81, a plurality of lasers 83, a plurality of prisms 85, a plurality of third lenses 87, a plurality of ferrules 88, second heat sink 89, and drive circuit 91.

Housing 81 houses lasers 83, prisms 85, third lenses 87, ferrules 88, second heat sink 89, and drive circuit 91.

Lasers 83 output laser light under the control of drive circuit 91. Lasers 83 can be semiconductor lasers that emit laser light from the violet wavelength band, which is shorter than that of blue laser light, to the blue wavelength band. Lasers 83 can also use, for example, an InGaN-based laser diode and an AlInGaN-based laser diode. It should be noted that the laser light emitted by lasers 83 may be light emitted by light emitting diodes (LEDs) as long as it is light for exciting the phosphors.

Lasers 83 are mounted on a board and are thermally connected to second heat sink 89 via the board. Each laser 83 causes laser light to enter an entrance surface which is the one end surface of a corresponding transmission component 11. In the present embodiment, the plurality of lasers 83 are divided into groups, and the laser light from each group of lasers 83 enters a corresponding prism 85. The laser light is light which excites wavelength converter 40. The laser light is, for example, light from the violet wavelength band to the blue wavelength band, and is capable of causing wavelength-converted light to be emitted from wavelength converter 40.

Each of prisms 85 is a light-transmissive plate-shaped component, and functions as a light guide that guides the laser light to a corresponding third lens 87. Prism 85 is disposed so as to be orthogonal to the optical axis of laser light emitted by each laser 83, that is, prism 85 is disposed so as to be located opposite the corresponding group of lasers 83. Prism 85 causes the laser light emitted from the group of lasers 83 to enter a corresponding third lens 87.

The plurality of third lenses 87 are disposed so as to be in a one-to-one correspondence with the plurality of prisms 85. Third lens 87 condenses the laser light emitted from prism 85, and causes the condensed laser light to enter a corresponding transmission component 11. In the present embodiment, third lenses 87 are convex lenses but may be concave lenses.

Ferrules 88 are secured to housing 81 and hold one end of transmission components 11. Specifically, each ferrule 88 holds the one end of the corresponding transmission component 11 to enable entry of the laser light emitted from the corresponding third lens 87.

Second heat sink 89 is a heat-dissipating component that dissipates heat generated in lasers 83, and includes a plurality of fins. Second heat sink 89 secures the board on which lasers 83 are mounted.

Drive circuit 91 performs drive control of the output of each laser 83 so that each laser 83 emits a predetermined laser light. Furthermore, drive circuit 91 has a function of adjusting the laser light emitted by each laser 83.

Drive circuit 91 may be an oscillator that drives lasers 83 based on pulse signals. Drive circuit 91 is electrically connected to a power system using a power line, or the like, and supplies power to each of lasers 83.

[Light Apparatus Operation, Etc.]

In lighting apparatus 1 as described above, optical connector 20 is inserted into holder 150a of luminaire 5. Then, second engaging component 159a of first heat sink 151 and first engaging component 127 of casing 120 are aligned. Then, securing component 159 is inserted into and screwed together with second engaging component 159a and first engaging component 127. In this manner, optical connector 20 is installed in lighting apparatus 1. Furthermore, optical connector 20 can be removed from lighting apparatus 1 by removing securing component 159.

Furthermore, in lighting apparatus 1, the laser light emitted from respective lasers 83 enter the one end surface of transmission elements 11 secured by ferrules 88, via prisms 85 and third lenses 87. The laser light transmitted by transmission components 11 exits from the other end surface of transmission components 11 and enters the one end surface of optical component 130 of optical connector 20. The laser light is guided by optical component 130 and exit from the other end surface of optical component 130, and enter wavelength converter 40. The laser light that have entered wavelength converter 40 are wavelength converted and exit as wavelength-converted light. The wavelength-converted light enter second lens 155 or are reflected by reflecting component 157 toward second lens 155. Second lens 155 controls the light distribution of the wavelength-converted light that has entered, to emit light distribution-controlled light. In this manner, lighting apparatus 1 is capable of illumination using wavelength-converted light.

[Effects]

Next, the effects of lighting apparatus 1 according to the present embodiment will be described.

As described above, lighting apparatus 1 according to this embodiment includes: lasers 83 that emit laser light; transmission components 11 that transmit the laser light; optical connector 20 into which the laser light transmitted by transmission components 11 enters, and from which the laser light is emitted; wavelength converter 40 that emits wavelength-converted light according to the laser light emitted from optical connector 20; first lens 30 that causes the laser light emitted from optical connector 20 to enter wavelength converter 40; and luminaire 5 that emits the wavelength-converted light. Furthermore, luminaire 5 includes holder 150a that removably holds optical connector 20. In addition, optical connector 20 includes: optical component 130 that is light-transmissive, mixes the laser light that has entered, and emits the laser light that has been mixed; and case 120 that houses optical component 130 and part of transmission components 11, and has a light-blocking property. Furthermore, first lens 30 is disposed in an optical path from optical connector 20 to wavelength converter 40.

In this manner, case 120 of optical connector 20 houses optical component 130. Case 120 prevents dirt, dust, or the like from being deposited in transmission components 11 and optical component 130. Accordingly, when laser light emitted from transmitting components 11 enter optical component 130, buildup of heat in transmission components 11 and optical component 130 due to dirt, dust, or the like being deposited on transmission components 11 and optical component 130 can be reduced.

Furthermore, optical connector 20 has a light-blocking property of blocking laser light passing inside optical connector 20. For this reason, optical connector 20 allows the guided laser light to pass inside case 120 prevents leakage to the outside (side leakage). Accordingly, it is possible to prevent causing personal injury due to leakage of laser light when optical connector 20 becomes unintentionally detached from luminaire 5.

Therefore, lighting apparatus 1 reduces damage to optical connector 20 and has excellent safety.

In particular, in lighting apparatus 1, optical connector 20 can smoothen (uniform) the output of exiting light by mixing the laser light that has entered. Accordingly, it is possible to prevent wavelength converter 40 from becoming locally hot due to the laser light. As a result, it is possible to suppress the deterioration of wavelength conversion efficiency due to heating up of wavelength converter 40.

Furthermore, in lighting apparatus 1 according to this embodiment, a gap between optical component 130 and transmission components 11 is enclosed by case 120.

Accordingly, it is possible to more reliably prevent dirt, dust, or the like, from being deposited on optical component 130 and transmission components 11. Accordingly, when laser light emitted from transmitting components 11 enter optical component 130, damage caused by buildup of heat in transmission components 11 and optical component 130 due to dirt, dust, or the like being deposited on transmission components 11 and optical component 130 can be reduced.

Furthermore, in lighting apparatus 1 according to this embodiment, transmission components 11 include a plurality of optical fiber cables.

In this manner, by using a plurality of optical fibers as transmission components 11, high output of laser light can be made to enter wavelength converter 40.

Furthermore, in lighting apparatus 1 according to this embodiment, optical component 130 is a rod integrator.

For this reason, by mixing the laser light that is guided, smoothened laser light (also referred to as top hat-type laser light) can be made to enter wavelength converter 40. As a result, it is possible to suppress the deterioration of wavelength conversion efficiency due to localized heating up of wavelength converter 40.

Furthermore, in lighting apparatus 1 according to this embodiment, optical component 130 is a diffuser that diffuses the laser light.

For this reason, by mixing the laser light, smoothened laser light can be made to enter wavelength converter 40. As a result, it is possible to suppress the deterioration of wavelength conversion efficiency due to heating up of wavelength converter 40.

Furthermore, since the diffuser has a light-transmissive plate shape, optical connector 20 can be made shorter than when optical component 130 is elongated.

Furthermore, in lighting apparatus 1 according to this embodiment, optical component 130 is a fly's eye lens.

For this reason, by mixing the laser light, smoothened laser light can be made to enter wavelength converter 40. As a result, it is possible to suppress the deterioration of wavelength conversion efficiency due to heating up of wavelength converter 40.

Furthermore, since the fly's eye lens has a light-transmissive plate shape, optical connector 20a can be made smaller than when optical component 130 is elongated.

Furthermore, in lighting apparatus 1 according to this embodiment, luminaire 5 includes: first heat sink 151 that is thermally connected to optical connector 20 and includes holder 150a; second lens 155 that controls light distribution of the wavelength-converted light; and reflecting component 157 that reflects the wavelength-converted light emitted from wavelength converter 40 toward the second lens.

For this reason, lighting apparatus 1 can emit light distribution-controlled light.

Furthermore, lighting apparatus 1 according to this embodiment includes: a plurality of lasers 83 that emit laser light beams and are grouped into one group of lasers 83; transmission component 11 that transmits, while mixing, the laser light beams emitted by the one group of lasers 83; optical connector 20 into which the laser light beams transmitted by transmission component 11 enter, that guides the laser light beams, and from which the laser light beams are emitted; wavelength converter 40 that converts a wavelength of the laser light beams guided by and emitted from optical connector 20, to emit wavelength-converted light beams; first lens 30 that causes the laser light beams emitted from optical connector 20 to enter wavelength converter 40; and luminaire 5 that emits the wavelength-converted light beams. Furthermore, luminaire 5 includes holder 150a that removably holds optical connector 20. Furthermore, optical connector 20 includes: optical component 130 that is light-transmissive, mixes the laser light that has entered, and emits the laser light that has been mixed; and case 120 that houses optical component 130 and part of transmission components 11, and has a light-blocking property. Furthermore, case 120 has opening 125b through which the laser light beams guided by optical component 130 pass. Furthermore, wavelength converter 40 converts the wavelength of the laser light beams passing through opening 125b of case 120. Furthermore, first lens 30 is disposed in an optical path from optical connector 20 to wavelength converter 40.

Furthermore, lighting apparatus 1 according to this embodiment includes: lasers 83 that emit laser light; transmission components 11 (examples of a cable) that transmit the laser light; optical connector 20 into which the laser light transmitted by the transmission components 11 enters and from which the laser light is emitted; wavelength converter 40 that emits wavelength-converted light according to the laser light emitted from optical connector 20; first lens 30 that causes the laser light emitted from optical connector 20 to enter wavelength converter 40; and luminaire 5 that emits the wavelength-converted light. Furthermore, luminaire 5 includes holder 150a that removably holds optical connector 20. In addition, optical connector 20 includes: optical component 130 (an example of a columnar body) that mixes the laser light that enters, and emits the laser light that has been mixed, optical component 130 being light-transmissive; and case 120 that houses optical component 130 and part of transmission components 11, case 120 including a light-blocking property. Furthermore, first lens 30 is in an optical path from optical connector 20 to wavelength converter 40.

### Embodiment 2

[Configuration]

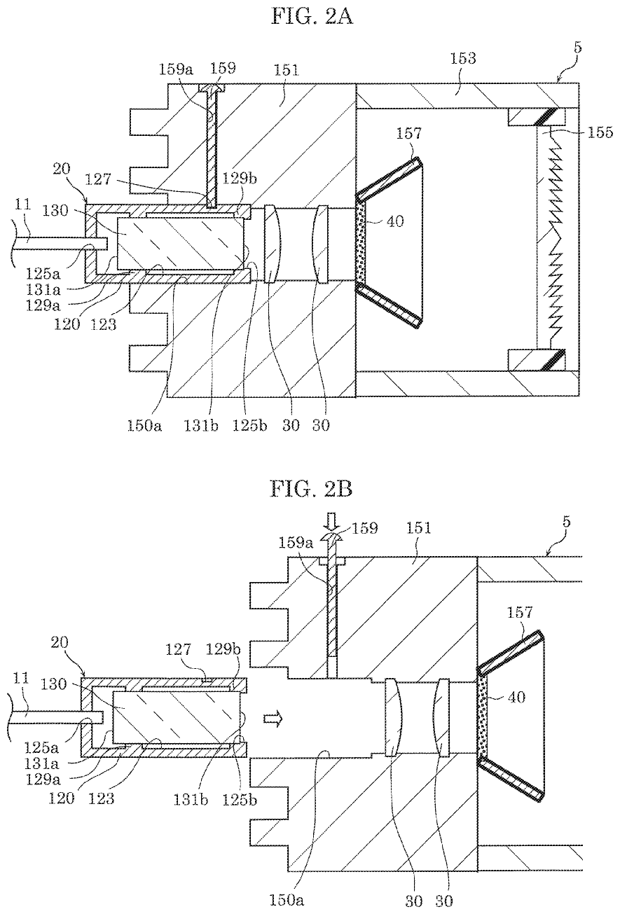

In the present embodiment, a lighting apparatus will be described with reference to FIG. 3.

FIG. 3 is an enlarged partial cross-sectional view of a lighting apparatus according to Embodiment 2.

In the present embodiment, components that are the same as those in lighting apparatus 1 in Embodiment 1 are given the same reference signs, and detailed description will be omitted.

In the present embodiment, wavelength converter 40 is attached to case 221 of optical connector 220. Specifically, wavelength converter 40 is secured by support piece 229d of case 221 so as to block opening 125b at the other end of case 221. For example, optical connector 220 is formed by wavelength converter 40, case 221, and transmission components 11 without gaps to prevent dirt, dust, or the like, from entering inside case 221. Furthermore, a plurality of first lenses 30 are disposed inside of case 221. First lenses 30 are disposed between optical component 230 and wavelength converter 40. First lenses 30 are secured by support pieces 229b and 229c inside case 221. For this reason, the laser light emitted from the other end surface of optical connector 220 passes through first lenses 30 and enter wavelength converter 40.

[Effects]

Next, the effects of the lighting apparatus according to the present embodiment will be described.

As described above, in the lighting apparatus according to this embodiment, case 221 is a cylindrical body and includes opening 125b through which the laser light passes. In addition, wavelength converter 40 is attached to case 221 to block opening 125b of case 221.

Accordingly, since wavelength-converted length exits from optical connector 220, even when optical connector 220 is unintentionally detached from luminaire 205, causing personal injury due to leakage of laser light can be prevented.

Furthermore, in the lighting apparatus according to this embodiment, first lens 30 is disposed between optical component 230 and wavelength converter 40, and is attached to case 221 to block opening 125b of case 221.

Accordingly, since deposition of dirt, dust, or the like, inside optical connector 220 is reduced, building up of heat in optical component 230 and transmission components 11 due dirt, dust, or the like, that has entered between optical component 230 and wavelength converter 40 can be prevented.

Furthermore, in the lighting apparatus according to the present embodiment, first lenses 30 are disposed between optical component 130 and wavelength converter 40 or between optical connector 220 and reflecting component 157.

The other effects of produced by the present embodiment are the same as those in Embodiment 1.

### Embodiment 3

[Configuration]

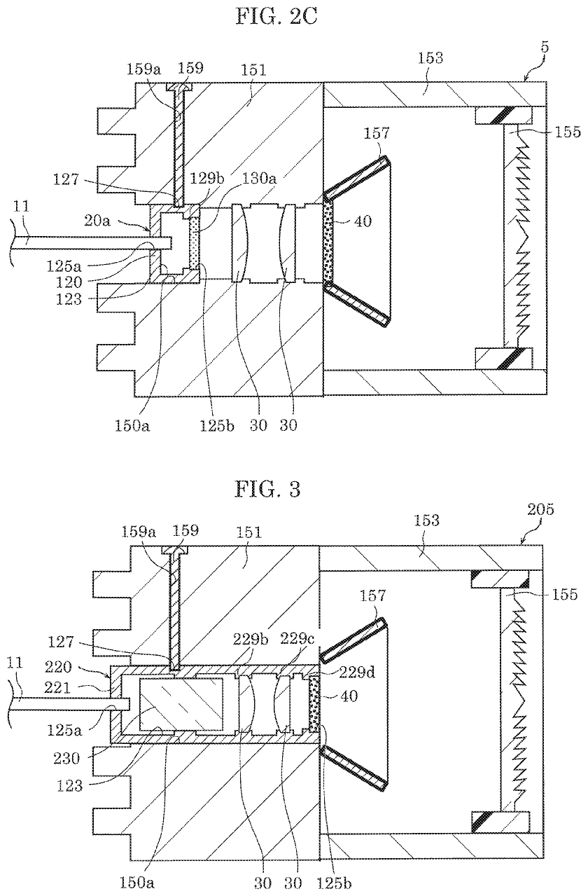

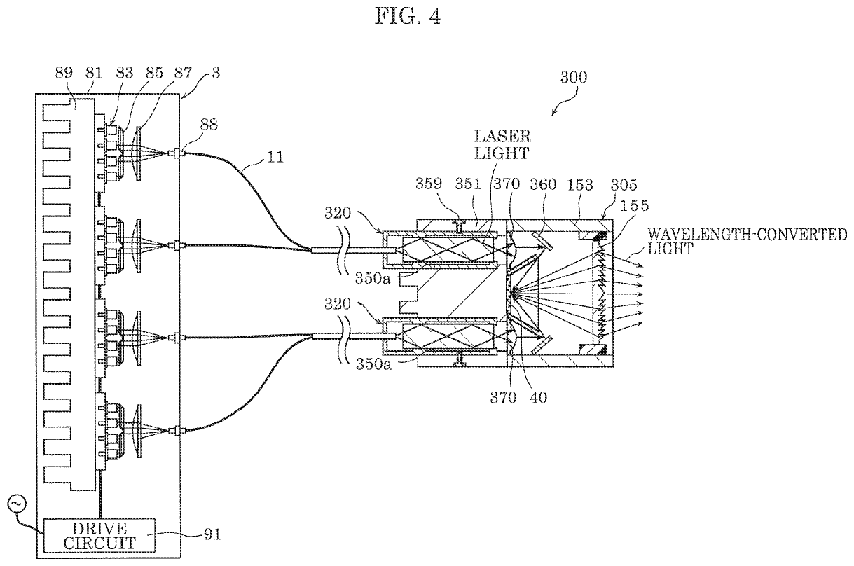

In the present embodiment, lighting apparatus 300 will be described with reference to FIG. 4 and FIG. 5.

FIG. 4 illustrates a schematic diagram excitation light source 3 and a cross-sectional view of luminaire 305, in lighting apparatus 300 according to Embodiment 3. FIG. 5 is an enlarged partial cross-sectional view of lighting apparatus 300 according to Embodiment 3.

In the present embodiment, components that are the same as those in lighting apparatus 1 in Embodiment 1 are given the same reference signs, and detailed description will be omitted.

As illustrated in FIG. 4 and FIG. 5, in the present embodiment, first heat sink 351 of luminaire 305 includes a plurality of holders 350a. In the present embodiment, two holders 350a are formed in first heat sink 351, but the configuration is not limited to such. In the present embodiment, two optical connectors 320 are inserted, one-to-one, into the two holders 350a. Although the laser light of two groups of lasers 83 enters one optical connector 320, the number of groups may be three or more or one.

As illustrated in FIG. 5, the two holders 350a are formed at positions away from central axis O of first heat sink 351 denoted by the dot-dash line. Wavelength converter 40 is secured to the other end surface of first heat sink 351 at a position that crosses central axis O of first heat sink 351, and is thermally connected to first heat sink 351. In other words, in order to facilitate dissipation of heat generated in wavelength converter 40, one end of wavelength converter 40 is in contact with the other end surface of first heat sink 351. Here, when luminaire 305 is elongated as illustrated in FIG. 5 in the present embodiment for example, central axis O is an axis that passes through the center of luminaire 305 in the lengthwise direction.

It should be noted that, although not illustrated in the figure, a reflector may be disposed between wavelength converter 40 and first heat sink 351.

As illustrated in FIG. 4 and FIG. 5, luminaire 305 further includes a plurality of light-reflectors 360. Light-reflectors 360 are secured to exterior portion 153. Specifically, each light-reflector 360 is secured to exterior portion 153 in an orientation in which the laser light emitted from optical connector 320 is reflected toward wavelength converter 40. It should be noted that a slit that allows laser light to pass through is formed in reflecting component 157 so that the laser light reflected by reflecting component 360 is not blocked. However, by adjusting the position of light-reflectors 360 and the beam spot of first lenses 370 so that the laser light is not obstructed by reflecting component 157, a slit need not be formed in reflecting component 157. For this reason, forming a slit in reflecting component 157 is not an essential requirement.

In this manner, the laser light emitted from optical connectors 320 are condensed by first lenses 370 and are incident on light-reflectors 360. The laser light is reflected by light-reflectors 360, pass by reflecting component 157, and enter wavelength converter 40. Wavelength converter 40 converts the laser light that has entered into wavelength-converted light, and the reflector reflects the laser light and the wavelength-converted light toward second lens 155. Accordingly, second lens 155 controls the light distribution of the laser light and the wavelength-converted light that have entered, to emit light distribution-controlled laser light and wavelength-converted light.

[Effects]

Next, the effects of lighting apparatus 300 according to the present embodiment will be described.

As described above, in lighting apparatus 300 according to the present embodiment, luminaire 305 further includes light-reflectors 360 that reflect the laser light emitted from first lenses 370 toward wavelength converter 40. Then, wavelength converter 40 is secured to first heat sink 351 so as to be thermally connected first heat sink 351.

For this reason, since the heat generated in wavelength converter 40 by the laser light can be dissipated through first heat sink 351, deterioration of wavelength conversion efficiency due to the buildup of heat in wavelength converter 40 can be further suppressed.

Furthermore, in lighting apparatus 300 according to the present embodiment, wavelength converter 40 is secured to a surface of first heat sink 351 so as to overlap with central axis O passing through first heat sink 351. In addition, optical connectors 320 are secured to first heat sink 351 at positions that do not overlap with central axis O.

The other effects of produced by the present embodiment are the same as those in Embodiment 1.

### Embodiment 4

[Configuration]

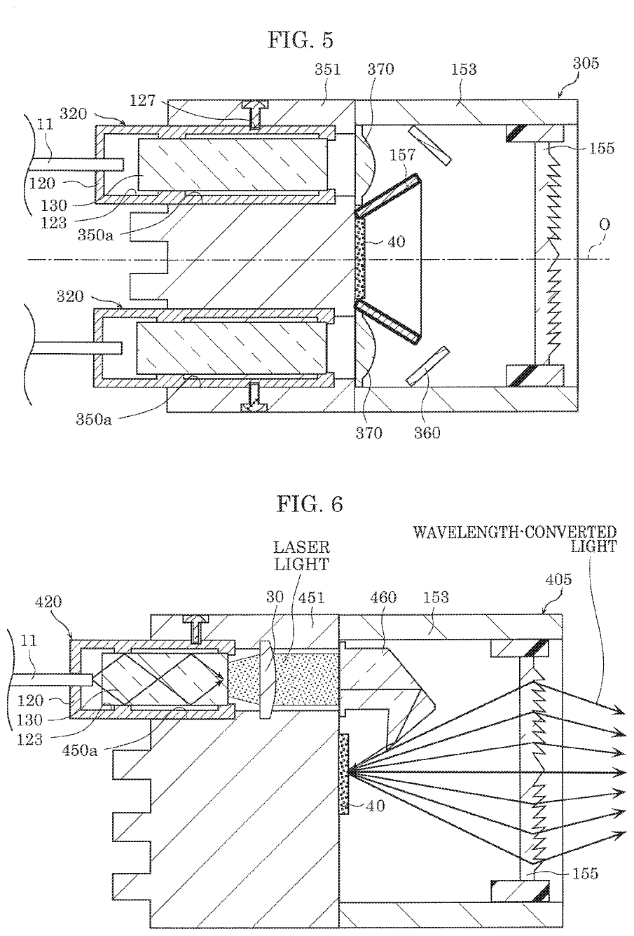

In the present embodiment, a lighting apparatus will be described with reference to FIG. 6.

FIG. 6 is an enlarged partial cross-sectional view of a lighting apparatus according to Embodiment 4.

In the present embodiment, components that are the same as those in lighting apparatus 300 in Embodiment 3 are given the same reference signs, and detailed description will be omitted.

As illustrated in FIG. 6, one holder 450a is formed in first heat sink 451 in the present embodiment but the number of holders is not limited to such, and two or more holders 450a may be formed.

Luminaire 405 further includes light guide 460. Light guide 460 is secured to first heat sink 451 so as to cover holder 450a at the other end surface of first heat sink 451. Specifically, light guide 460 is secured to first heat sink 451 such that laser light does not leak out from between first heat sink 451 and light guide 460, that is, so that the laser light passing through holder 450a enters wavelength converter 40. In this manner, light guide 460 guides the light emitted from first lens 30 up to wavelength converter 40. It should be noted that light guide 460 may be secured to exterior portion 153.

In the present embodiment, light guide 460 is claw-shaped in cross-sectional view, and has at least one reflecting surface. Light guide 460 may guide the laser light to wavelength converter 40 using one reflecting surface, but the number of reflecting surfaces is not limited. Furthermore, the shape of light guide 460 depends on the number of reflecting surfaces, and thus is not limited to a claw shape. Specifically, any shape is acceptable as long as light guide 460 guides the laser light emitted from optical connector 420 up to wavelength converter 40.

In this manner, the laser light emitted from optical connector 420 is collimated by first lens 30 and enters light guide 460. The laser light is guided by light guide 460 and enters wavelength converter 40. Wavelength converter 40 converts the laser light that has entered into wavelength-converted light, and reflects the laser light and the wavelength-converted light toward second lens 155. Accordingly, second lens 155 controls the light distribution of the laser light and the wavelength-converted light that have entered, to emit light distribution-controlled laser light and wavelength-converted light.

[Effects]

Next, the effects of the lighting apparatus according to the present embodiment will be described.

As described above, in the lighting apparatus according to the present embodiment, luminaire 405 further includes light guide 460 which guides the laser light emitted from first lens 30 up to wavelength converter 40. Then, wavelength converter 40 is secured to first heat sink 451 so as to be thermally connected first heat sink 451.

For this reason, since the heat generated in wavelength converter 40 by the laser light can be dissipated through first heat sink 451, deterioration of wavelength conversion efficiency due to the buildup of heat in wavelength converter 40 can be further suppressed.

The other effects of produced by the present embodiment are the same as those in Embodiment 1.

### VARIATIONS, ETC

Although the present disclosure is described above based on Embodiments 1 to 4, the present disclosure is not limited to Embodiments 1 to 4.

For example, in the lighting apparatus according to Embodiment 2, the first lens is disposed between the optical component and the wavelength converter, but may be disposed between the optical connector and the reflecting component.

Furthermore, in the lighting apparatuses according to Embodiments 1 to 4, the optical connectors are freely attachable to and detachable from the luminaire, the means for attaching and detaching is not limited to the means describe above, and commonly known means may be used.

Aside from the above, forms obtained by various modifications to Embodiments 1 to 4 that can be conceived by a person of skill in the art as well as forms realized by arbitrarily combining structural components and functions in Embodiments 1 to 4 which are within the scope of the essence of the present disclosure are included in the present disclosure.

What is claimed is:

1. A lighting apparatus, comprising:
a laser that emits laser light;
a transmission component that transmits the laser light;
an optical connector into which the laser light transmitted by the transmission component enters and from which the laser light is emitted;
a wavelength converter that emits wavelength-converted light according to the laser light emitted from the optical connector;
a first lens that causes the laser light emitted from the optical connector to enter the wavelength converter; and
a luminaire that emits the wavelength-converted light, wherein
the luminaire includes a holder that removably holds the optical connector,
the optical connector includes:
an optical component that mixes the laser light that enters, and emits the laser light that has been mixed, the optical component being light-transmissive; and
a case that houses the optical component and part of the transmission component, the case including a light-blocking property, and
the first lens is in an optical path from the optical connector to the wavelength converter.

2. The lighting apparatus according to claim 1, wherein
the case is a cylindrical body and includes an opening through which the laser light passes, and
the wavelength converter is attached to the case and blocks the opening of the case.

3. The lighting apparatus according to claim 2, wherein
the first lens is disposed between the optical component and the wavelength converter, is attached to the case, and blocks the opening of the case.

4. The lighting apparatus according to claim 1, wherein
the case encloses a gap between the optical component and the transmission component.

5. The lighting apparatus according to claim 1, wherein
the transmission component includes a plurality of optical fiber cables.

6. The lighting apparatus according to claim 1, wherein
the optical component is a rod integrator.

7. The lighting apparatus according to claim 1, wherein
the optical component is a diffuser that diffuses the laser light.

8. The lighting apparatus according to claim 1, wherein
the optical component is a fly's eye lens.

9. The lighting apparatus according to claim 1, wherein
the luminaire includes:
a heat sink that is thermally connected to the optical connector and includes the holder;
a second lens that controls light distribution of the wavelength-converted light; and
a first reflector that reflects the wavelength-converted light, emitted from the wavelength converter, toward the second lens.

10. The lighting apparatus according to claim 9, wherein
the luminaire further includes a second reflector that reflects the laser light, emitted from the first lens, toward the wavelength converter, and
the wavelength converter is secured and thermally connected to the heat sink.

11. The lighting apparatus according to claim 9, wherein
the luminaire further includes a light guide that guides the laser light, emitted from the first lens, to the wavelength converter, and
the wavelength converter is secured and thermally connected to the heat sink.

12. The lighting apparatus according to claim 9, wherein
the first lens is one of between the optical component and the wavelength converter or between the optical connector and the reflector.

13. The lighting apparatus according to claim 9, wherein
the wavelength converter is secured to a surface of the heat sink and overlaps with a central axis passing through the heat sink, and
the optical connector is secured to the heat sink at a position that does not overlap with the central axis.

14. A lighting apparatus, comprising:
a plurality of lasers that emit laser light beams and are grouped into one group of lasers;
a transmission component that transmits and mixes the laser light beams emitted by the one group of lasers;
an optical connector into which the laser light beams transmitted by the transmission component enter, that guides the laser light beams, and from which the laser light beams are emitted;
a wavelength converter that converts a wavelength of the laser light beams guided by and emitted from the optical connector, and emits wavelength-converted light beams;
a first lens that causes the laser light beams emitted from the optical connector to enter the wavelength converter; and
a luminaire that emits the wavelength-converted light beams, wherein
the luminaire includes a holder that removably holds the optical connector,
the optical connector includes:
an optical component that mixes the laser light beams that enter, and emits the laser light beams that have been mixed, the optical component being light-transmissive; and
a case that houses the optical component and a part of the transmission component, the case including a light-blocking property,
the case includes an opening through which the laser light beams guided by the optical connector pass,
the wavelength converter converts the wavelength of the laser light beams passing through the opening of the case, and
the first lens is in an optical path from the optical connector to the wavelength converter.

15. A lighting apparatus, comprising:
a laser that emits laser light;
a cable that transmits the laser light;
an optical connector into which the laser light transmitted by the cable enters and from which the laser light is emitted;
a wavelength converter that emits wavelength-converted light according to the laser light emitted from the optical connector;
a lens that causes the laser light emitted from the optical connector to enter the wavelength converter; and
a luminaire that emits the wavelength-converted light, wherein
the luminaire includes a holder that removably holds the optical connector,
the optical connector includes:
a columnar body that mixes the laser light that enters, and emits the laser light that has been mixed, the columnar body being light-transmissive; and
a case that houses the columnar body and part of the cable, the case including a light-blocking property, and
the lens is in an optical path from the optical connector to the wavelength converter.
